(19) United States
(12) Patent Application Publication
(10) Pub. No.: US 2005/0011357 A1
(43) Pub. Date: Jan. 20, 2005

(54) Method and system for flushing ash from a diesel particulate filter

(76) Inventor: Wilbur H. Crawley, Columbus, IN (US)

Correspondence Address: CARLSON, GASKEY & OLDS, P.C., 400 WEST MAPLE ROAD, SUITE 350, BIRMINGHAM, MI, 48009, US

(21) Appl. No.: 10/619,231

(22) Filed: Jul. 14, 2003

(51) Int. Cl. B01D 46/00

(52) U.S. Cl. 95/281; 96/228; 96/233

(57) ABSTRACT

A system for flushing ash from a diesel particulate filter includes a conduit for supplying a fluid from a fluid supply to an outlet of a diesel particulate filter. A pump slowly reverse flows the fluid through the diesel particulate filter. An acoustic wave source generates an acoustic wave, such as an ultrasonic wave, through the fluid in the diesel particulate filter to assist in dislodging the ash from the diesel particulate filter, while the fluid carries the ash out the inlet of the diesel particulate filter. The ash may be filtered from the fluid after the fluid exits the diesel particulate filter, so that the fluid may be reused.

### BACKGROUND OF THE INVENTION

The present invention relates generally to exhaust filters and more particularly to a system and method for cleaning a diesel particulate filter.

Most diesel engines will soon be required to be provided with diesel particulate filters or traps. Generally, the filter includes a housing containing filter media having a plurality of thin-walled parallel passages extending longitudinally through the trap. Each passage is hollow and bounded by openings at each longitudinal end. At each end, alternate openings are closed, so that each passage is closed at one of its ends and open at the other and adjacent passages are closed at opposite ends. Any exhaust gas or combustion product that enters the filter through an unplugged opening must pass through the semi-permeable thin walls in order to exit the filter. Particulate matter unable to pass through the walls is thereby filtered to prevent emission to the atmosphere. A filter of this kind is described in U.S. Pat. No. 4,504,294.

These diesel particulate filters require a burner to oxidize carbon trapped in the diesel particulate filter, thus creating carbon dioxide. Problems occur with oil and fuel additives because they create ash that will not burn off. The ash can vary based upon the additives, but phosphorous, magnesium, and calcium are the primary components of the ash. The ash must be periodically removed from the diesel particulate filter to ensure proper performance.

### SUMMARY OF THE INVENTION

The present invention provides a system and method for cleaning the ash from a diesel particulate filter. In a preferred embodiment of the system and method according to the present invention, a conduit supplies fluid from a fluid supply to the outlet of the diesel particulate filter. The fluid flows slowly into the outlet of the diesel particulate filter through the filter and out of an inlet of the diesel particulate filter. In one embodiment, an acoustic wave generator sends acoustic waves, such as ultrasonic waves, through the fluid in the diesel particulate filter. The acoustic waves assist in dislodging the ash from the diesel particulate filter. The reverse flow of the fluid through the diesel particulate filter carries the dislodged ash from the diesel particulate filter.

### BRIEF DESCRIPTION OF THE DRAWING

Other advantages of the present invention can be understood by reference to the following detailed description when considered in connection with the accompanying drawing wherein:

FIG. 1 schematically illustrates one embodiment of the inventive system for flushing ash from a diesel particulate filter.

### DETAILED DESCRIPTION OF THE PREFERRED EMBODIMENTS

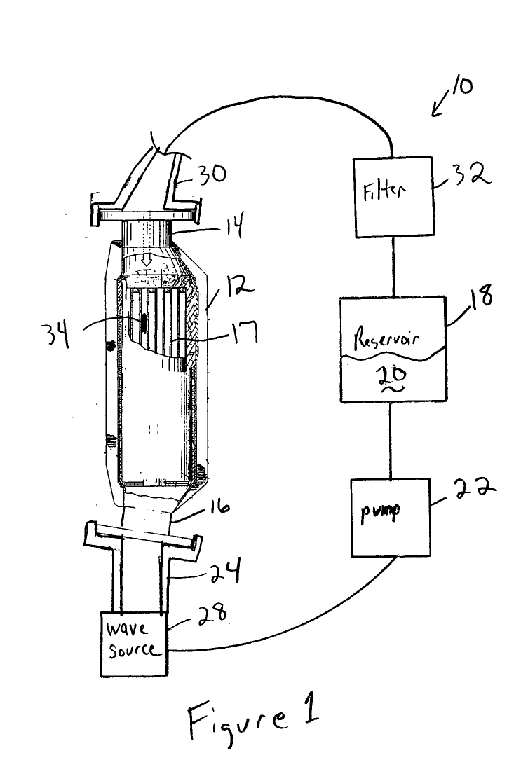

A diesel particulate filter flushing system 10 according to one embodiment of the present invention is shown in FIG. 1 flushing a diesel particulate filter 12 of the type described above having an inlet 14, an outlet 16 and filter media 17. As used herein, the terms “inlet” and “outlet” of the diesel particulate filter 12 refer to the direction of flow of exhaust through the diesel particulate filter 12 when in use with an engine, prior to the removal of ash in the manner according to the present invention.

The system 10 includes a reservoir 18 containing a supply of fluid 20, such as water, air or solvent, and a pump 22 for flowing the fluid 20 out through a supply conduit 24. An acoustic wave generator 28 imparts acoustic waves in the fluid 20 as it leaves the supply conduit 24. The acoustic wave generator 28 in this embodiment is an ultrasonic wave generator. A return conduit 30 returns fluid 20 through a filter 32 back to the reservoir 18.

In use, ash 34 builds up in the filter media 17 of the diesel particulate filter 12 over time. The ash 34 is primarily from oil and fuel additives, which produce ash that does not burn off the filter media 17. The buildup of ash 34 in the diesel particulate filter 12 degrades the performance of the diesel particulate filter 12.

For periodic cleaning of the diesel particulate filter 12 in a method according to the present invention, the supply conduit 24 is connected to the outlet 16 of the diesel particulate filter 12 and the return conduit 30 is connected to the inlet 14 of the diesel particulate filter 12. The pump 22 then begins slowly flowing the fluid 20 in the reverse direction through the diesel particulate filter 12. The acoustic wave generator 28 imparts ultrasonic waves in the fluid 20 in the diesel particulate filter 12. The ultrasonic waves assist in dislodging the ash 34 from the filter 17. The fluid 20 carries the ash out through the inlet 14 of the diesel particulate filter 12 and out into the return conduit 16. The ash and fluid 20 flow through the return conduit 16 to the filter 32, where the ash is removed from the fluid 20 so that the fluid 20 can be reused in the system 10.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

1. A method for cleaning a diesel particulate filter including the steps of:
a) flowing a fluid into an outlet of a diesel particulate filter;
b) dislodging ash from the filter with the fluid; and
c) carrying the ash in the fluid through an inlet of the filter.

2. The method of claim 1 further including the step of sending acoustic waves through the fluid to assist in dislodging ash in said step b).

3. The method of claim 2 wherein the acoustic waves are ultrasonic waves.

4. The method of claim 3 wherein the fluid is a liquid.

5. The method of claim 4 wherein the fluid is water.

6. The method of claim 1 further including the step of filtering the fluid after it flows out of the inlet of the filter to remove the ash from the fluid.

7. The method of claim 1 further including the step of securing a first conduit to the outlet of the filter and a second conduit to the inlet of the filter prior to said step a).

8. A system for cleaning a diesel particulate filter comprising:
a supply of a fluid;
a first conduit for connecting to an outlet of a diesel particulate filter to the supply of the fluid; and
a pump for flowing the fluid into the outlet of the diesel particulate filter.

9. The system of claim 8 further including an acoustic wave source coupled to the fluid in the diesel particulate filter.

10. The system of claim 9 wherein the acoustic wave source is an ultrasound generator.

11. The system of claim 8 further including a filter for removing ash from the fluid after the fluid exits an inlet of the diesel particulate filter.

12. A method for cleaning a diesel particulate filter including the steps of:
a) flowing a fluid into a diesel particulate filter;
b) imparting an acoustic wave on the fluid in the diesel particulate filter to dislodge ash from the filter with the fluid; and
c) flowing the ash and the fluid out of the filter.

13. The method of claim 12 wherein the fluid is a liquid.

14. The method of claim 12 wherein the fluid is water.

15. The method of claim 12 wherein the acoustic wave is an ultrasonic wave.

16. The method of claim 12 wherein said step a) further includes the step of flowing the fluid into an outlet of the diesel particulate filter and wherein said step c) further includes the step of flowing the ash and the fluid out of an inlet of the diesel particulate filter.

17. The method of claim 16 further including the steps of filtering the fluid after it exits the diesel particulate filter and returning the filtered fluid to the filter.

18. The method of claim 1 wherein the fluid is steadily flowed into the outlet in said step a).

19. The method of claim 18 wherein the fluid is a liquid.

20. The method of claim 19 further including the step of sending acoustic waves through the liquid to assist in dislodging ash in said step b).
